(19) United States
(12) Patent Application Publication
(10) Pub. No.: US 2023/0136781 A1
(43) Pub. Date: May 4, 2023

(54) DEVICE AND METHOD FOR WETTING BIOLOGICAL MATERIAL WITH AT LEAST ONE LIQUID, AND RETAINING APPARATUS

(71) Applicant: PRIME23 GMBH, Rapperswil (CH)

(72) Inventor: Xaver EINSLE, Gebertingen (CH)

(21) Appl. No.: 17/918,562

(22) PCT Filed: Mar. 30, 2021
(86) PCT No.: PCT/EP2021/058320

§ 371 Date: Oct. 12, 2022

(30) Foreign Application Priority Data
Apr. 14, 2020 (DE) 10 2020 204 670.0

(51) Int. Cl. G01N 1/31

(52) U.S. Cl. CPC G01N 1/31

(57) ABSTRACT

A device for wetting biological material with at least one liquid, comprising at least one retaining device and at least suction device, wherein the retaining device serves to receive a specimen slide in a support plane, wherein the specimen slide carries the biological material, and wherein the suction device serves to suction off liquid from the retaining device, wherein a front side of the suction device does not extend parallel to the support plane. Furthermore, a retaining device for a device for wetting biological material with at least one liquid and a method for wetting biological material with at least one liquid are disclosed.

### BACKGROUND

### Technical Field

This disclosure relates to a device for wetting biological material with at least one liquid, comprising at least one retaining device and at least one suction device or means, wherein the retaining device serves to receive a specimen slide in a support plane, wherein the specimen slide carries the biological material, and wherein the suction device or means serves to suction off liquid from the retaining device.

Furthermore, the disclosure relates to a suction device or means for a device for wetting biological material with at least one liquid, having a free end for suctioning off the liquid.

Furthermore, the disclosure relates to a method for wetting biological material with at least one liquid.

### Description of the Related Art

Devices and methods of the type in question are used, for example, for automated processing of biological materials mounted on a plurality of microscopic specimen slides and individually processed in incubation chambers. The principle field of application is the field of diagnostics of anatomical pathology.

A corresponding device is known, for example, from DE 10 2016 225 885 A1. This document describes a special retaining device for a specimen slide, in which the specimen slide is tilted during processing according to a protocol developed for this purpose, several times at fixed points in time and work steps in a continuous movement about the three coordinate axes. In this manner, liquid located between the specimen slide and the retaining device can drain off. Moreover, this device comprises a cover with an outlet, which is designed as a suction nozzle and is anchored in the cover. The end of the suction nozzle that meets the specimen slide is bulged out like a funnel or trumpet and is pressed onto the corner area of the specimen slide upon closure of the cover. In the collection position of the specimen slide, the suction nozzle is in fluid communication with the corner area of the device through the connection with the specimen slide. In this manner, the fluid can be suctioned up from the capillary gap between the specimen slide and the bottom plate by means of the suction nozzle. Additionally, it is described to provide the free end of the suction nozzle with a recess that can accommodate the corner area of the specimen slide.

However, neither these or other known suction systems can ensure repeated, complete suction of the liquids from the capillary gap between the bottom of the specimen slide and the bottom of the retaining device for the specimen slide with sufficient reliability. This leads, among other things, to liquid needing to be removed manually from the device, or to an incorrect or no result at all being displayed, whereby the processing of further samples is delayed.

### BRIEF SUMMARY

Embodiments of the present invention are therefore based on the task of designing and further developing a device of the type mentioned above in such a way that trouble-free operation is made possible by constructionally simple means. Furthermore, improved means of suction and an improved method for wetting biological material with at least one liquid are to be provided.

According to embodiments of the invention, the abovementioned task is solved by the features of a device for wetting biological material with at least one liquid, comprising at least one retaining device and at least one suction device or means, wherein the retaining device serves to receive a specimen slide in a support plane, wherein the specimen slide carries the biological material, wherein the suction or means serves to suction off liquid from the retaining device, and wherein a front side of the suction device or means does not extend parallel to the support plane.

In accordance with aspects of the invention, it has firstly been recognized that the suction of liquid from the capillary gap between the specimen slide and the bottom of the retaining device can be considerably improved in an amazingly simple manner if the front side of the free end of the suction device or means—at least during suction—does not extend parallel to the support plane or alternatively to the specimen slide arranged in/on the retaining device.

In a further manner according to aspects of the invention, it has been recognized that if the means of suction—as in the prior art—is directed perpendicularly to the upper side of the specimen slide and that the specimen slide slips in such a way that the opening in the free end of the means of suction is blocked, the liquid can no longer be suctioned off. This can occur, in particular, with the European design of specimen slides which, for example, are only 25 mm wide and at the same time are formed with right angle corners. The non-parallel arrangement of the free end according to embodiments of the present invention prevents such a blockage since, in the event of a slipped specimen slide, the vacuum suction continues to be directed through the gap or gaps of the non-parallel front side of the suction device or means. For example, the free end of the suction device or means could extend into the corner defined by one of the side walls and the back wall of the retaining device.

It has also been recognized that it is of particular importance for the complete suctioning off of all reagents from the retaining device that the, preferably double, inclination of the free end of the suction device or means remains statically at the defined inclination, in particular x-y inclination, with respect to the support plane, this irrespective of whether and, if so, how strongly a specimen slide is deflected. Any deflection of the specimen slide serves only to collect the liquid reagents in a suction area.

In the context of the present disclosure, the “support plane” is defined by the surface upon which the specimen slide is placed. In particular, this is the bottom of the retaining device. Inasmuch as the support or alternatively support points for the specimen slide are formed on the retaining device, these define the support plane. In this way, a specimen slide arranged in the retaining device lies within the support plane or alternatively is arranged at least parallel to the support plane. Inasmuch as the specimen slide can be deflected, this has no influence on the definition or alternatively on the position of the support plane, which is thus defined by the area of the retaining device upon which the specimen slide rests in the non-deflected state (basic state). In other words, the term “slant” refers to the position of the elements of the claimed device in which they are located during suction.

Advantageously, the front side can extend in a slanted manner with respect to the support plane. By the front side extending in a slanted manner with respect to the support plane or alternatively to a specimen slide arranged on the retaining device, the free end of the suction device or means “becoming stuck” is prevented, so that an uninterrupted fluid connection with the capillary gap is realized.

In a further advantageous manner, the front side can extend overall in a single plane. A corresponding embodiment has the advantage that it can be implemented particularly easily due to its geometry, even with the small dimensions required in such a device. By way of example, the front side can be formed at a hose-like end of the suction device or means, with the free end being formed or cut off at in a slanted manner.

Alternatively, the front side could be concave or convex or stepped or irregular, for example, rippled. That which is essential is that the design and arrangement of the free end is such that the free end is prevented from becoming stuck, thereby ensuring that the vacuum suction is maintained.

According to a further advantageous embodiment, the front side of the suction device or means can be slanted. In this way, the suction device or means can project essentially vertically into the retaining device in accordance with the prior art device, wherein the slanting design of the front side ensures that it does not extend parallel to the support plane.

In a particularly advantageous manner, the front side can extend at an angle in the range from 5° to 45°, in particular from 5° to 40°, preferably from 10° to 30°, with respect to the support plane. In the case of an angle in the range from 5° to 45°, liquid is already extracted much more reliably than with the suction nozzles known from the prior art, wherein the reliability is substantially improved once again at an angle in the range from 5° to 40°. Ideally, the angle can be in the range of 10° to 30°, which enables a particularly trouble-free operation. The angle described here is defined by the angle between the normal vector of the support plane and the normal vector of the plane defined by the front side. In a particularly advantageous manner, the front side can be doubly slanted with respect to the support plane. In this case, the front side is tilted both about a first straight line and about a second straight line, wherein the first straight line and the second straight line each lie in the support plane and extend at right angles to one another. In this way, the support plane can be defined by the first straight line and the second straight line. Using such an embodiment, it is, for example, possible that the front side is inclined both in the direction of the back wall and in the direction of one of the side walls of the retaining device, whereby a particularly reliable suctioning off is realized, in particular if the front side projects into the area of the corner of this side wall and the back wall.

In a further advantageous manner, at least during a suction process, the front side can be in contact with the specimen slide and a side wall of the retaining device and a back wall of the retaining device. This creates small gaps between these three points of contact, between which a certain amount of ambient air is sucked in so that the free end is prevented from getting stuck in place.

According to a further advantageous embodiment, the free end of the suction device or means, in particular the front side of the suction device or means, can, at least during a suction process, be in contact with the specimen slide and with a—possibly rounded—corner of the retaining device, wherein the—possibly rounded—corner connects a back wall and a side wall of the retaining device. This construction measure also ensures that a fluid channel of the suction device or means is not closed.

In order to realize a particularly easy-to-manufacture design, the suction device or means can be designed, at least in some areas, as a hose or tube. The hose or alternatively the tube could thus be arranged and/or formed in such a way that the free end extends in a slanted manner with respect to the support plane, at least during suction. For this purpose, in a particularly simple manner, the free end of the hose or tube could be formed to be slanted, for example, cut off in a slanted manner In a particularly advantageous embodiment, the suction device or means overall could be formed as a hose or tube. Furthermore, this suction device or means could be arranged in a tubing guide element. In this, it is essential that the front side of the suction device or means does not extend parallel to the support plane.

In a further advantageous way, a bottom of the retaining device may have at least two planes, such that an upper bottom surface and a lower bottom surface are realized. In other words, the bottom may be stepped. The lower bottom surface thereby forms a space for receiving the liquid that is used for wetting, this in order to generate and maintain a relatively high-moisture atmosphere on the bottom side of the specimen slide for a defined period of time during prolonged in situ hybridization (ISH). In this manner, liquid will continue to flow from the lower bottom surface into the area between the upper bottom surface and the bottom side of the specimen slide if the liquid in the area between the upper bottom surface and the bottom of the specimen slide evaporates. In this context, the terms “upper bottom surface” and “lower bottom surface” refer to the arrangement of the retaining device during use, during which the upper bottom surface is arranged vertically at a greater height than the lower bottom surface.

Furthermore, it is conceivable that at least one support is formed on the lower bottom surface which projects at least substantially up to the height of the upper bottom surface. This ensures that a specimen slide that is put in place extends at least essentially parallel to the lower and upper bottom surfaces or alternatively is, at most, slightly tilted at the edge between the upper bottom surface and the lower bottom surface. As long as one or more upper supports are disposed on the upper bottom surface, then the at least one lower support is advantageously configured such that the ends of the upper support and the ends of the lower support are at the same level.

In a further advantageous manner, the support of the lower bottom surface can be formed spaced apart from further elements of the retaining device such that it projects freely from the lower bottom surface. In this case, it is advisable that the free-standing support is designed to be point-shaped. Such a solitary lower support is advantageous in that it only comes into contact with the liquid reagents if this is desired, such as for example, as a basin or storage area for auxiliary reagents, for example, wash buffer or antigen retrieval solutions, or in the case in which the reagents are not suctioned up. Normally, the user will simply add sufficient volume to the upper bottom plate of reagents until it is completely full. This reduces the consumption of the expensive reagents, which is particularly advantageous in the case of in situ hybridization. The further advantage of the solitary standing bottom support is that reagents do not adhere to such a bottom support when the specimen slide is lifted for suction. It depends on the viscosity of the individual reagents whether they adhere to a protrusion (support).

A retaining device comprising a lower and an upper bottom surface has the advantage—irrespective of further embodiments of the retaining device—that a variable reagent volume can be defined by a shorter upper bottom surface in relation to a longer lower bottom surface. Furthermore, a lower bottom surface of constant length can be used as a reservoir for reagents, especially for auxiliary reagents. A third advantage is that, inasmuch as the device has a heating device for heating the liquid found in the retaining device, it is possible with a single size of heating element to control the temperature of retaining devices of different sizes or alternatively of different lengths by the variable upper bottom surface. Inasmuch as the back wall and thus the suction components always remain in the same place, there is no need for further design changes. The fact that the longer lower bottom surface is also temperature controlled at the same time is irrelevant. This allows for a complicated and costly design with heating elements of different sizes to be dispensed with, which would need to be assigned to different length retaining devices with only one bottom plate.

In a particularly advantageous manner, at least one support surface can be formed on a bottom of the retaining device, wherein the support surface extends from a side wall to a back wall of the retaining device. Such a support surface may be formed on the upper bottom surface of a retaining device having a lower bottom surface and an upper bottom surface, such that it is the upper support described above. Inasmuch as a lower support is provided, it can preferably extend at the same height as the upper support so that a specimen slide is held straight. By a correspondingly flat design of the support surface it is possible to use all traditional sizes of specimen slides (for example the European version with the dimensions 25 mm×75 mm, as well as the version used in the USA with the dimensions 1 inch×3 inch), as well as all embodiments of the corners of the specimen slides as support points or alternatively support surfaces. For the special 3-D tilting movement of the specimen slide, as described in DE 10 2016 225 885.0, this design of the support surfaces has proved ideal. In this case, corresponding support surfaces are ideally formed in the two corners between the side walls and the back wall.

Embodiments of the suction device or means disclosed herein could advantageously have an outlet which projects from a base body of the suction device or means and/or is formed as a hose or is alternatively hose-like. In particular, the outlet could extend—preferably vertically—in an upwards direction when the device is ready for operation. It is here conceivable that the vacuum, which is generated continuously or on demand, is connected to the suction device or means in such a way that a movable connection, such as, for example, a suction hose or tube, is directed or placed onto the outlet of the suction device or means, for example from above, by an articulation or another suitable device. This connection process could be synchronized with the insertion of the cartridge. The movable connection could thereby lead to a container for used reagents. Whenever the processing, for example, a staining process, is completed and therefore the cartridge is to be removed, a movable connection could synchronously open again by the deflection about an articulation, through the removal of the cartridge. One is here dealing with a counter-rotating synchronous motion, such as the connection or closing of the connector and suction device or means. If this closing and opening process is combined with the crimping of the hose, then the hose is crimped upon connection of the connector and the suction device or means of the hose and eased again when they are opened.

The underlying task is further solved by a suction device or means for a device for wetting biological material with at least one liquid with a free end for suctioning off the liquid, wherein the front side of the free end is formed in a slanted manner and/or can be arranged in such a way that the front side extends in a slanted manner with respect to a support plane for a specimen slide.

In a manner according to embodiments of the invention, it has been recognized that the suction of liquid from the capillary gap between the underside of the specimen slide and a receiving area for the specimen slide is substantially more reliable if the front side of the free end is formed in a slanted manner and/or alternatively can be arranged in such a way that it extends in a slanted manner with respect to the support plane.

A method for wetting biological material with at least one liquid is also disclosed, wherein, is arranged, in a device, a retaining device comprising an upper bottom surface and a lower bottom surface with a specimen slide held therefrom, wherein the specimen slide is lifted off the retaining device such that liquid located on the lower bottom surface is directed to the upper bottom surface.

The method according to the invention makes it possible in a particularly simple manner to wet the biological material with a liquid, wherein the smallest possible quantities of the liquid are necessary. In concrete terms, it has been recognized that liquid can be directed from a lower bottom surface, serving, for example, as a reservoir or basin, to the upper bottom surface by lifting the specimen slide, for example, by a rocker or a push rod. Due to adhesive forces acting between the bottom surface of the specimen slide and the liquid, the liquid is also lifted sufficiently so that it can flow along the bottom surface of the specimen slide onto the upper bottom surface.

It is expressly noted that the device according to embodiments of the invention has features which are distinct to the method, so that part of the disclosure described herein is also a method according to the invention, which may have one or more of the features and advantages described with respect to the device according to the invention.

The disclosure further relates to a retaining device, in particular a device for wetting biological material with at least one liquid, wherein the retaining device serves to receive a specimen slide carrying the biological material, and wherein a bottom of the retaining device has at least two planes in such a manner that an upper bottom surface and a lower bottom surface are realized. Alternatively, or additionally, a bottom of the retaining device could have at least two planes, such that an upper bottom surface and a lower bottom surface are realized. In this, it is further conceivable that a support is formed on the lower bottom surface, preferably projecting freely from the bottom surface, which support projects at least substantially up to the height of the upper bottom surface.

### BRIEF DESCRIPTION OF THE SEVERAL VIEWS OF THE DRAWINGS

There are now various possibilities for advantageously designing and further developing the teaching of the present invention. For this purpose, reference should be made on the one hand to the claims and on the other hand to the following explanation of advantageous embodiments of the invention with reference to the drawings. In connection with the elucidation of the advantageous embodiments of the invention on the basis of the drawings, generally advantageous configurations and further developments of the teaching are also elucidated. In the drawings:

FIG. 1 shows a perspective view of an embodiment example of a device for wetting biological material with a liquid in a schematic representation,

FIG. 2 shows a perspective view of a further embodiment example of a device for wetting biological material with a liquid in a schematic representation,

FIG. 3 shows a perspective side view of an embodiment example of a suction device or means in a schematic representation,

FIG. 4 shows a perspective side view of the suction device or means according to FIG. 3 in a further schematic representation,

FIG. 5 shows a perspective side view of the suction device or means according to FIG. 3 in a further schematic representation,

FIG. 6 shows a perspective side view of a further embodiment of a suction device or means in a schematic representation,

FIG. 7 shows a perspective side view of the suction device or means according to FIG. 6 in a further schematic representation,

FIG. 8 shows a perspective view of a part of the embodiment example of a device according to the invention in a schematic representation,

FIG. 9 shows a perspective view of a part of the embodiment example according to FIG. 8 in a further schematic representation,

FIG. 10 shows a perspective side view of an embodiment example of a retaining device for use in a device for wetting biological material with a liquid in a schematic representation,

FIG. 11 shows the retaining device according to FIG. 10 in a further schematic representation,

FIG. 12 shows a perspective side view of a further embodiment of a retaining device for use in a device for wetting biological material with a liquid in a schematic representation,

FIG. 13 shows the retaining device according to FIG. 12 in a further schematic representation,

FIG. 14 shows a perspective side view of a further embodiment of a retaining device for use in a device for wetting biological material with a liquid in a schematic representation, and

FIG. 15 shows a perspective side view of a further embodiment of a suction device or means in a schematic representation.

### DETAILED DESCRIPTION

In the figures, the same elements are provided with the same reference signs. Furthermore, for the sake of clarity, not all elements are provided with a reference sign in each figure.

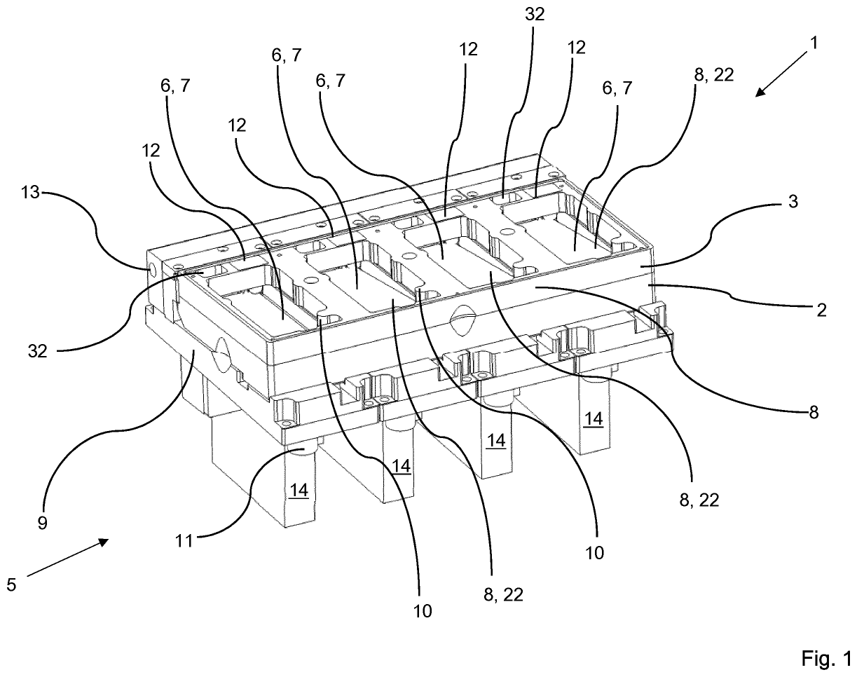

FIG. 1 shows a perspective view of a device according to an example embodiment of the invention for wetting biological material with a liquid in a schematic representation, wherein this embodiment serves generally to illustrate the general operation of such a device.

The device has a cartridge 1 consisting of a cartridge bottom 2 and a cartridge cover 3. The cartridge cover 3 is closed off by a cover disc 4 not shown in this embodiment.

The cartridge 1 is arranged on the console 5 and has a total of four cells 6, each of which is for one retaining device 7. A specimen slide 8 is placed on each of the retaining devices 7, which lies in the support plane 22 or extends parallel to it.

According to FIG. 1, the console 5 has a plate 9 which is designed as a single component, wherein the plate 9 can also be designed in several parts, for example, a first plate and a second plate could be provided.

It can be clearly seen that the plate 9 is formed on a slant. The slant can be in the range from 1.5° to 5°, in particular from 2° to 4°, preferably 3°. The slanted course of the plate 9 can be formed independently of the further construction of the device. This ensures that liquid that is pipetted into the retaining device 7 runs in the direction of any optional overflow channel formed in the cartridge bottom 2. In addition, the slant enables any bubbles in the liquid to better ascend.

Furthermore, four electric motors 11 are configured which serve as a drive for a deflection device not shown, by way of which the specimen slide 8 can be deflected in the cartridge 1. To enable tilting of the specimen slide 8 about its longitudinal axis, a protrusion 10 is provided against which a corner region of the specimen slide 8 abuts when the specimen slide 8 is lifted.

In addition, a suction arrangement can be seen, which suction arrangement comprises the suction device or means 12 and hose or conduit 13 serving as fluid connections, by which the liquid can be suctioned out of the individual retaining devices 7. For this purpose, the suction device or means 12 is connected by way of hoses or conduits 13, for example, to a pump or another device for generating a vacuum. Control means 14, for example electronic boards, are also provided. It is essential that the front side 18 of the free end 16 of the suction device or means 12 extends in a slanted manner with respect to the support plane 22 of the retaining device 7 or to the upper side of the specimen slide 8 arranged thereon. A pipetting opening 32 is formed next to each of the suction device or means 12, through which pipetting opening liquid or alternatively reagents can be introduced/applied to the retaining device 7.

The cartridge 1 and the console 5 can be connected to each other via magnets which are not shown. Likewise, the cartridge bottom 2 and the cartridge cover 3 may be connected to each other via magnets.

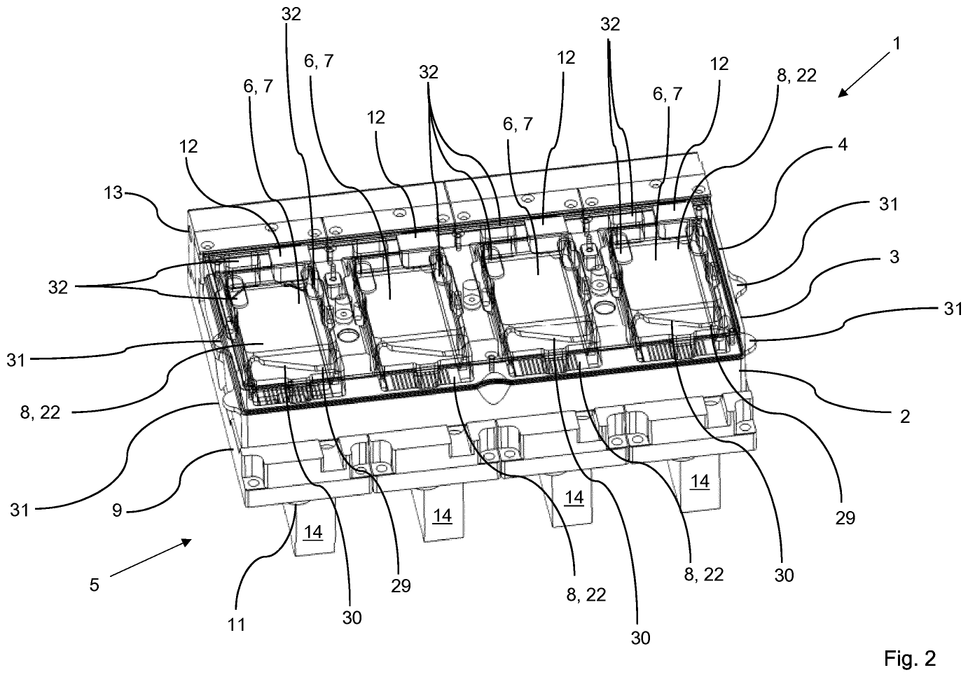

FIG. 2 shows a further embodiment example of a device for wetting biological material with a liquid. This corresponds essentially to the device shown in FIG. 1, so that reference is made to the description thereof. The main difference to the device shown in FIG. 1, is that the impact point realized in FIG. 1 as protrusion 10 is now realized as strut 29, which has a slant 30 on its side facing the specimen slide 8. The slant 30 serves to limit the maximum tilt of the specimen slide 8 about its longitudinal axis. In this manner, the slant 30 defines the maximum rotation. This defines a maximum angle at which suction can be optimally performed in conjunction with the suction device or means 12. Optimal suction exists, in particular, when a light vacuum suction that is fast (for example, a maximum duration of 2 seconds) and that does not leave any residues takes place. Furthermore, small tabs 31 are attached to the side walls of the cartridge cover 3 and to the cartridge bottom 2 respectively, which serve as points of application such that the components held together by magnetic forces can be separated more easily by hand.

FIG. 2 moreover shows the transparent cover disc 4. An identically constructed cover disc 4 can be arranged in the device according to FIG. 1. In this, it can be seen that two pipetting openings 32 are also formed in the cover disc 4 for each retaining device 7. In this manner, three pipetting openings 32 are formed on each retaining device 7, such that several liquids can be mixed particularly easily. However, the cover disc 4 can also have none, only one or more than two pipetting openings 32 for each retaining device 7. A barcode field 33 is usually formed on the specimen slides 8 so that the specimen slides 8 can be clearly identified.

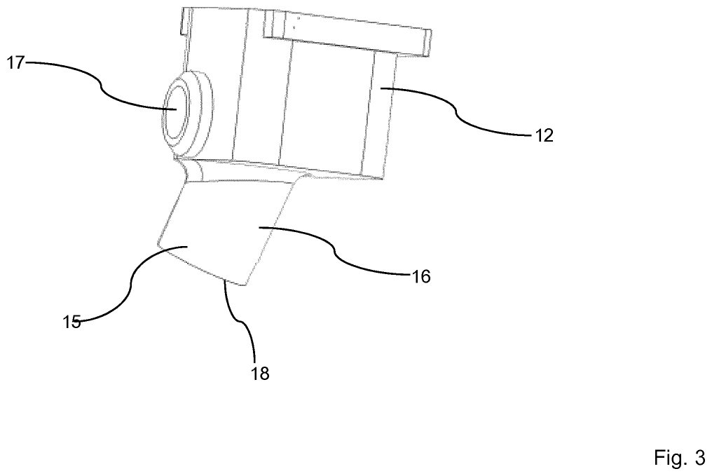

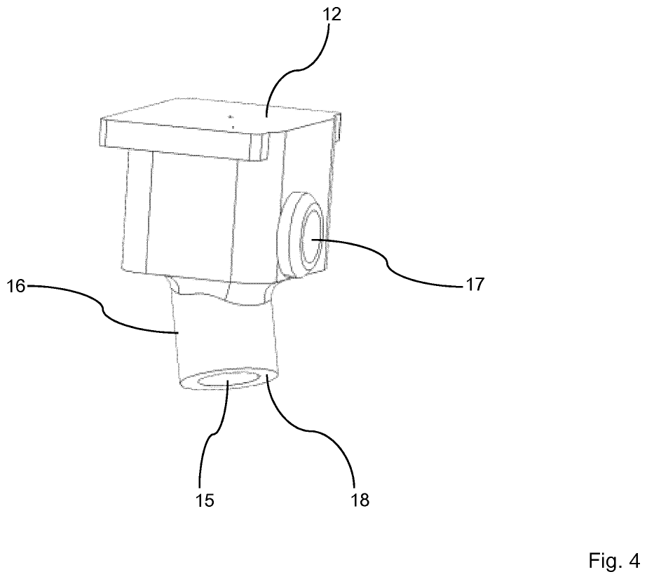

FIGS. 3 to 5 show different representations of an embodiment example of a suction device or means 12 according to the invention. The suction device or means 12 has a suction channel which extends from the fluid inlet 15 of the free end 16 to the fluid outlet 17. It can be clearly seen that the free end 16 is formed in a slanted manner, so that when the suction device or means 12 is arranged, for example, in a device according to FIG. 1, the front side 18 does not extend parallel to the support plane 22. Since the front side 18 extends on a slant to the support plane 22 of the retaining device 7 or alternatively to the upper side of the specimen slide 8 arranged thereon, the front side 18 does not get stuck to the specimen slide 8 and/or the retaining device 7, in such a way that liquid can be suctioned off in an extremely reliable manner It is conceivable that the free end 16 is arranged opposite the retaining device 7 in such a way that it projects into a corner 19 of the retaining device 7, which is formed by a side wall 19 and a back wall 20.

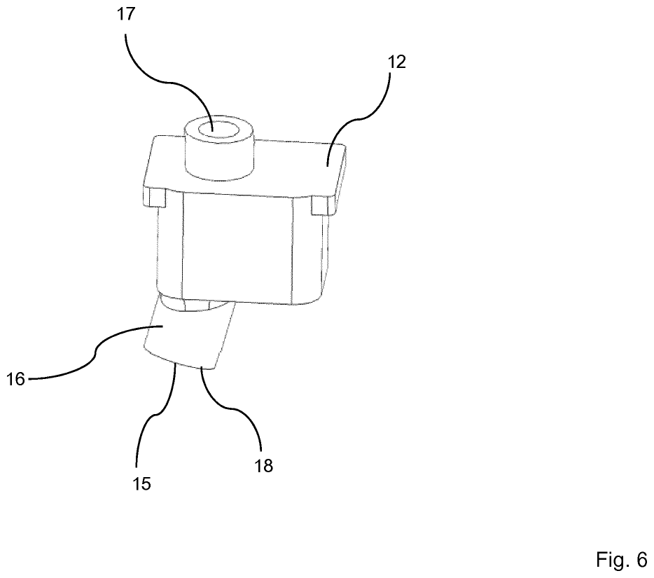

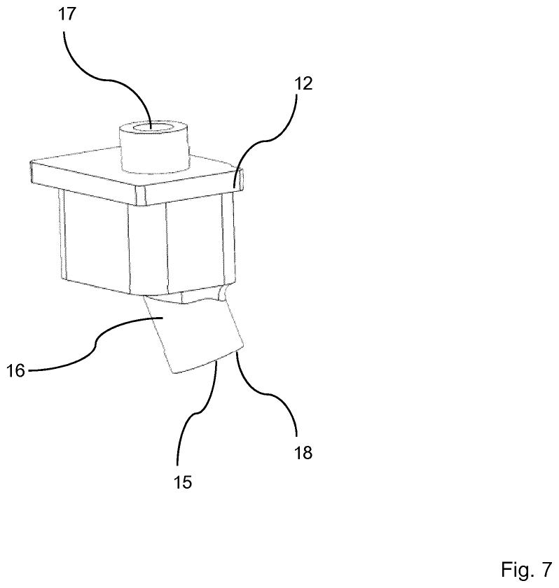

FIG. 6 and FIG. 7 show different representations of a further embodiment example of a suction device or means 12. In this case, the suction device or means 12 has a fluid outlet 17 which, when installed in a device in ready-to-use state, extends at least substantially upwards, which is to say vertically. Such a suction device or means 12 is particularly suitable for the case in which the vacuum, which is generated continuously or on demand, is connected to the suction device or means 12 in such a way that a movable connection, for example, a suction hose or tube, is directed or placed onto the outlet of the suction device or means, for example, from above, by way of an articulation or other suitable device. This connection process could be synchronized with the insertion of the cartridge.

Furthermore, the suction device or means 12 shown in FIG. 6 and FIG. 7 corresponds to the embodiment according to FIGS. 3 to 5, so that reference is made to the description thereof in order to avoid repetition.

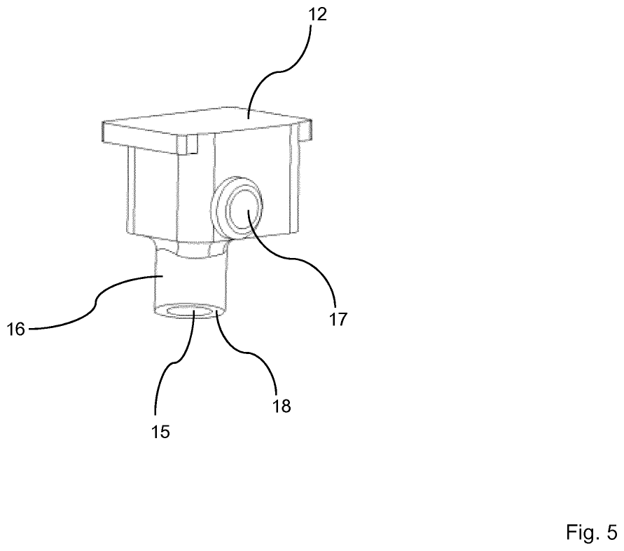

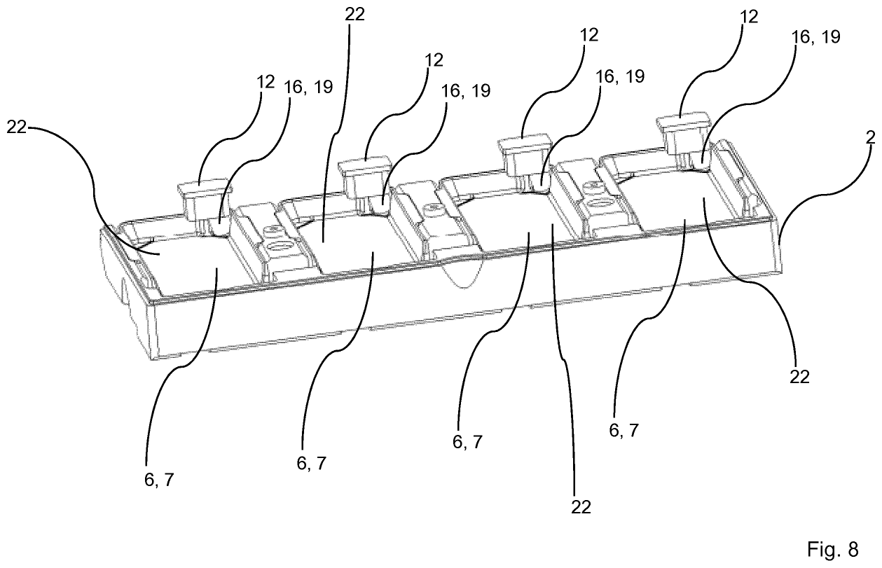

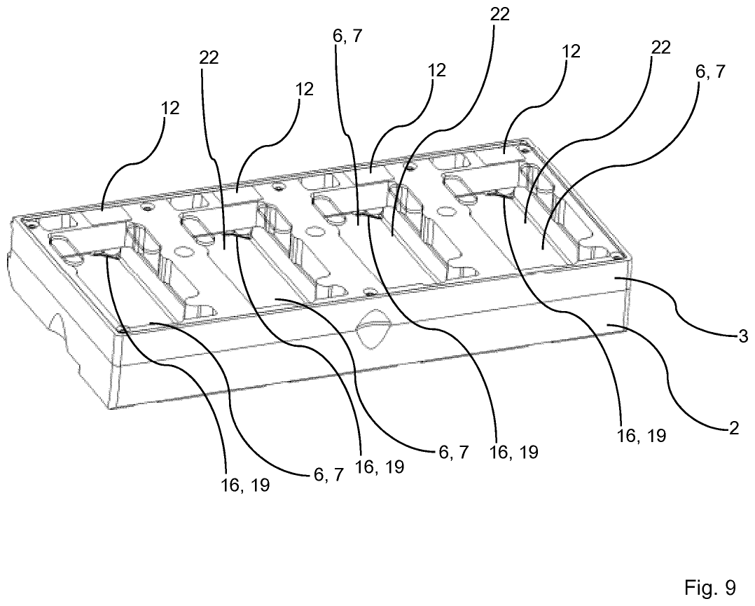

FIG. 8 and FIG. 9 show schematic representations of a part of a device according to embodiments of the invention. In concrete terms, FIG. 8 shows a cartridge bottom 2 with four cells 6, in each of which a retaining device 7 is accommodated. The number of cells 6 can be lesser or higher, for example, only one single cell 6 and thus one single retaining device 7 can be provided. Furthermore, it is shown how the suction device or means 12 are arranged during the suction process. The suction device or means 12 correspond to the suction device or means 12 shown in FIGS. 5 to 7 and are each positioned opposite a retaining device 7 in such a way that the free end 16 projects into the corner 19 of the retaining device 7, the front side 18 not being parallel but inclined or slanted with respect to the support plane 22.

FIG. 9 shows the cartridge bottom 2 together with the retaining device 7 and suction device or means 12 according to FIG. 8 as well as a cartridge cover 3. The suction device or means 12 are arranged in the cartridge cover 3 (not shown in FIG. 5) in such a manner that in the closed state, they project into the corners 19 of the retaining device 7. In this way, the front sides 18 of the suction device or means 12 do not extend parallel to the support planes 22, but rather on a slant or inclined.

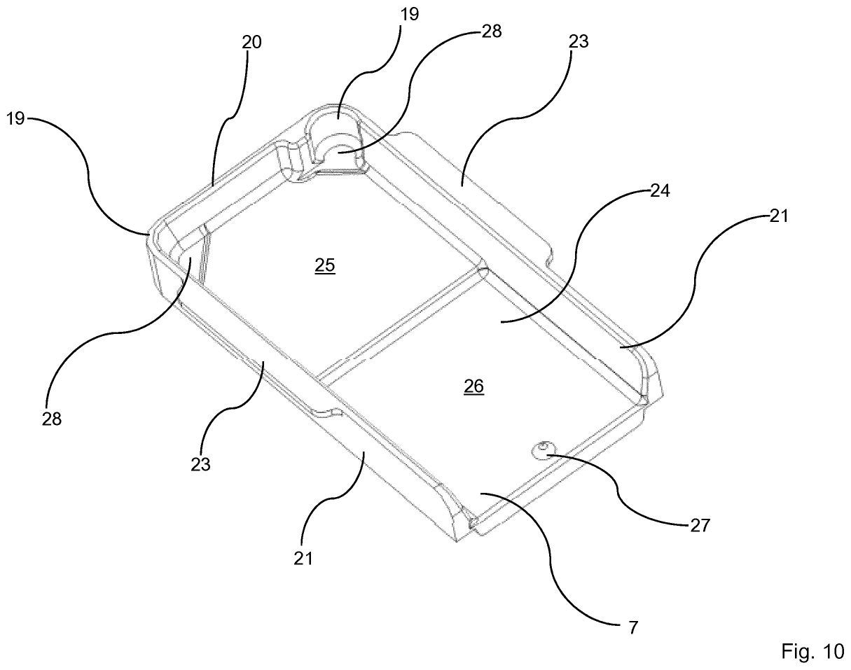

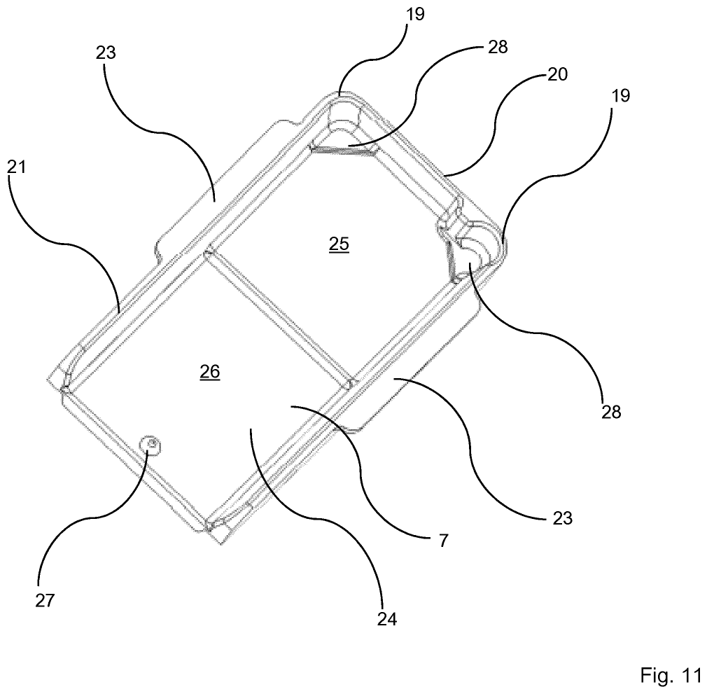

FIG. 10 and FIG. 11 show an embodiment example of a retaining device 7. The retaining device 7 has two side walls 21 and a back wall 20. Support tabs 23 are formed on the side walls 21, with which the retaining device 7 rests in/on the cells 7. Furthermore, it can be clearly seen that the bottom 24 has an upper bottom surface 25 and a lower bottom surface 26. The lower bottom surface 26 serves as a reservoir for holding liquid. If the liquid on the upper bottom surface 25 evaporates, the liquid is drawn up from this reservoir. A support 27 for the specimen slide 8 is further formed on the lower bottom surface 26. The support 27 is implemented here in the form of a point, but it can also be formed in the form of a surface or a line. Several possibly differently designed supports 27 can also be arranged. Support surfaces 28 are formed in each of the corners 19. Overall, the specimen slide 8 therefore rests on the support 27 as well as the support surfaces 28, such that the free ends of the support 27 as well as the support surfaces 28 define the support plane 22.

In FIG. 10 and FIG. 11, it can also be clearly seen that the support surfaces 28 each extend from a side wall 21 to the back wall 20 and are thus—depending on the design of the corner 19—essentially triangular or triangular with a semicircle at the apex. In this way, specimen slides 8 with different dimensions—for example, both 25 mm×75 mm as well as 1 inch×3 inch—can be accommodated.

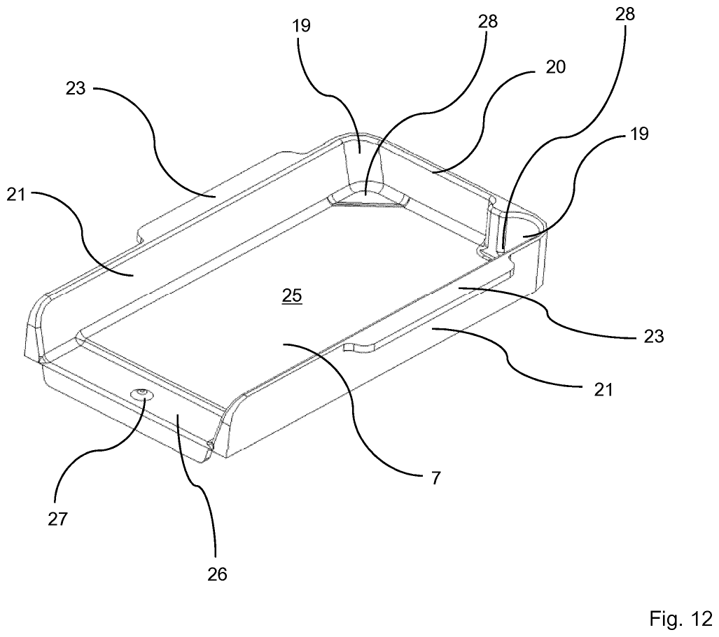

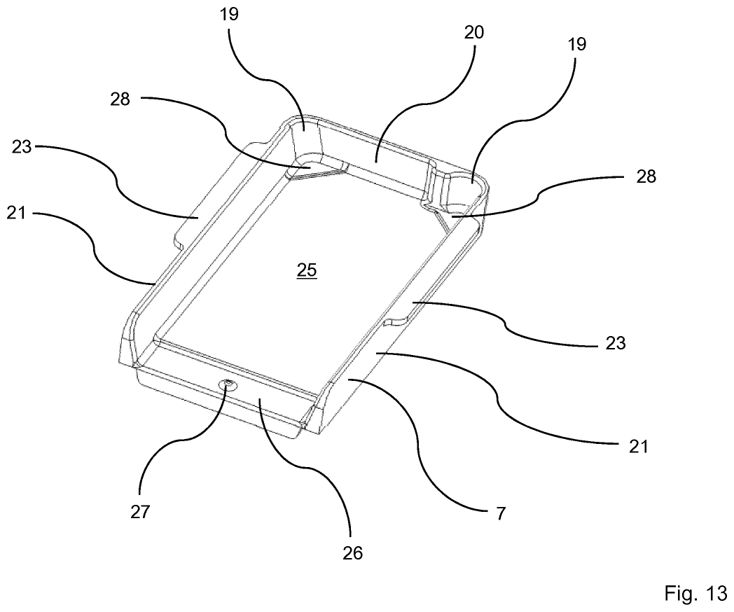

FIG. 12 and FIG. 13 show another embodiment example of a retaining device 7. This corresponds to the retaining device 7 shown in FIG. 10 and FIG. 11, with the difference that the upper bottom surface 25 is considerably larger or alternatively longer than the lower bottom surface 26. By way of example, the upper bottom surface 25 could have a length (going from the back wall 20 to support 27) of 55 mm. This allows reagents to reach the barcode field of a specimen slide, even if the specimen slide has a relatively large barcode field. A retaining device 7 according to FIG. 12 and FIG. 13 can be operated in such a way that the support 27 does not come into contact, or hardly comes in contact with the liquid.

Furthermore, reference is made to the description of FIG. 10 and FIG. 11, which applies analogously to FIG. 12 and FIG. 13.

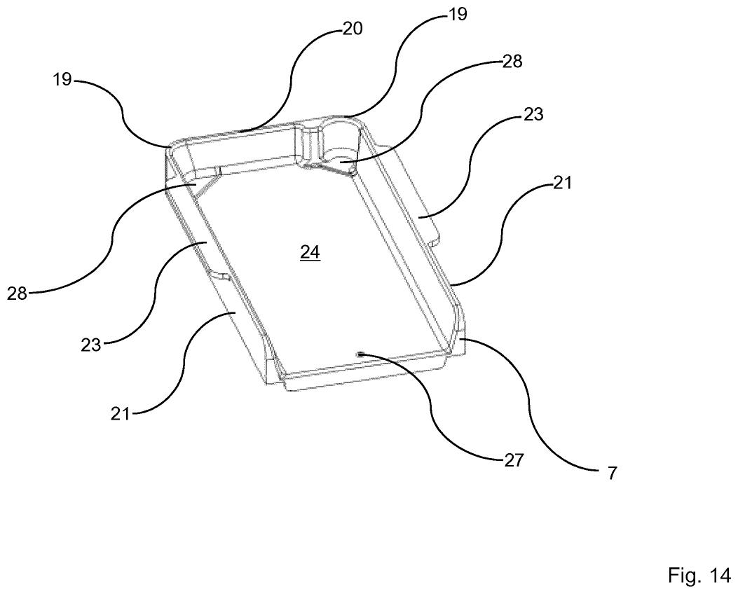

FIG. 14 shows another embodiment example of a retaining device 7. This corresponds to the retaining device 7 shown in FIG. 10 and FIG. 11, with the difference that the bottom 24 has a single continuous bottom surface. Furthermore, reference is made to the description of FIG. 10 and FIG. 11, which applies analogously to FIG. 14.

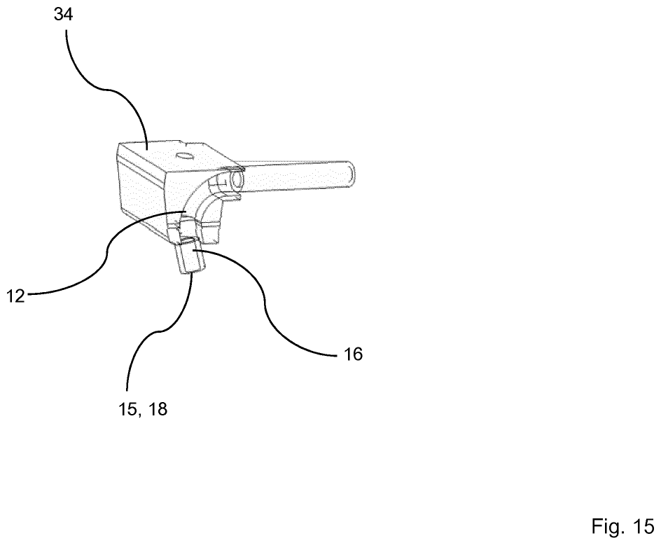

FIG. 15 shows a further embodiment example of a suction device or means 12. The suction device or means 12 is formed as a hose that defines a suction channel that extends from the fluid inlet 15 of the free end 16. It can be clearly seen that the free end 16 is formed in a slanted manner, so that when the suction device or means 12 is arranged, for example, in a device according to FIG. 1, the front side 18 does not extend parallel to the support plane 22. In this way, the embodiment example according to FIG. 15 corresponds essentially to the embodiment example shown in FIGS. 3 to 5, with the difference that the suction device or means 12 is realized overall by a hose arranged in a tubing guide element 34.

With regard to further advantageous embodiments of the device according to the invention, reference is made to the general part of the description and to the appended claims in order to avoid repetition.

Finally, it should be expressly noted that the above-described embodiment examples of the device according to the invention merely serve to discuss the claimed teaching, but do not restrict it to the embodiment examples.

In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device for wetting biological material with at least one liquid, the device comprising:
at least one retaining device and at least suction device, wherein the retaining device serves to receive a specimen slide in a support plane, wherein the specimen slide carries the biological material, wherein the suction device serves to suction off liquid from the retaining device, and wherein a front side of the suction device does not extend parallel to the support plane.

2. The device according to claim 1, wherein the front side of the suction device extends in a slanted manner with respect to the support plane.

3. The device according to claim 1, wherein the front side of the suction device extends overall in a single plane.

4. The device according to claim 1, wherein the front side of the suction device is concave or convex or irregularly shaped.

5. The device according to claim 1, wherein the front side of the suction device is formed in a slanted manner.

6. The device according to claim 1, wherein the front side of the suction device extends at an angle in the range from 5° to 45° with respect to the support plane.

7. The device according to claim 1, wherein the front side of the suction device is in contact with the specimen slide and a side wall of the retaining device and a back wall of the retaining device at least during a suction process.

8. The device according to claim 1, wherein a free end of the suction device is in contact with the specimen slide and with a rounded corner of the retaining device at least during a suction process, wherein the rounded corner connects a back wall and a side wall of the retaining device to one another.

9. The device according to claim 1, wherein the suction device is formed at least in regions as a hose or tube.

10. The device according to claim 1, wherein a bottom of the retaining device has at least two planes, such that an upper bottom surface and a lower bottom surface are realized.

11. The device according to claim 10, wherein a support is formed on the lower bottom surface, and wherein the support projects at least substantially up to the height of the upper bottom surface.

12. The device according to claim 11, wherein the support is formed spaced apart from further elements of the retaining device wherein it projects freely from the lower bottom surface.

13. The device according claim 1, wherein at least one support surface is formed on a bottom of the retaining device, and wherein the support surface extends from a side wall to a back wall of the retaining device.

14. The device according to claim 10, wherein a heating device with at least one heating element is arranged for heating the at least one retaining device, wherein the heating element is dimensioned in such a way that the entire bottom of the retaining device and/or, if appropriate, the entire upper bottom surface of the retaining device is sufficiently heated, irrespective of its size.

15. A suction device for a device for wetting biological material with at least one liquid, the suction device comprising: a free end for suctioning off the liquid,
wherein the front side of the free end is formed in a slanted manner and/or can be arranged in such a way that the front side extends in a slanted manner with respect to a support plane for a specimen slide.

16. A method for wetting biological material with at least one liquid, wherein in a device are arranged a retaining device comprising an upper bottom surface and a lower bottom surface with a specimen slide held therefrom, the method comprising:
lifting the specimen slide off the retaining device such that liquid located on the lower bottom surface is directed to the upper bottom surface.
